(19) United States
(12) Patent Application Publication
(10) Pub. No.: US 2022/0341228 A1
(43) Pub. Date: Oct. 27, 2022

(54) LOCKING HANDLE MECHANISM

(71) Applicant: FERCO ARCHITECTURAL HARDWARE INC., Laval (CA)

(72) Inventors: Maxime Emard, Montreal (CA); Sylvain Durand, Terrebonne (CA)

(21) Appl. No.: 17/644,441

(22) Filed: Dec. 15, 2021

Related U.S. Application Data
(60) Provisional application No. 63/178,723, filed on Apr. 23, 2021.

(51) Int. Cl. E05C 1/06; E05C 1/00

(52) U.S. Cl. CPC E05C 1/06; E05C 1/006

(57) ABSTRACT

A locking handle mechanism for windows is provided, the mechanism comprising a main body, a handle, a slider and snap fits. The slider comprises a slot housing part of the handle and side slits housing part of a locking mechanism of the window. The fork is displaced to lock and unlock the window by the rotation of the handle from a first position to a second position. Having two side slits allows for the installation of the mechanism on either side of a window frame. The main body may be installed to a window frame by piercing an appropriate hole and by securing with snap fits to the inside surface of the frame. Methods for installing and uninstalling a locking handle mechanism in a casement are further provided.

### CROSS-REFERENCE TO RELATED APPLICATIONS

The present patent application claims the benefits of priority of U.S. Provisional Patent Application No. 63/178,723, entitled “LOCKING HANDLE MECHANISM”, and filed at the United States Patent and Trademark Office on Apr. 23, 2021, the content of which is incorporated herein by reference.

### FIELD OF THE INVENTION

The present invention generally relates to the field of window hardware, more precisely to the field of locking handle mechanisms for casement or awning windows.

### BACKGROUND OF THE INVENTION

Casement locking handles are typically screwed into the frame of the casement window profile. U.S. Pat. No. 5,087,087 shows a locking handle screwed from the side through the housing, into the side of the frame. This is more common for wooden windows. U.S. Pat. No. 5,829,802 shows a locking handle screwed from behind, which can be used for any type of profile. This type of installation requires a two-step cut-out in the frame profile. The first cut goes through the whole profile to let the mechanism reach the sash, and the second cut goes through only a portion of the profile (first wall for hollow profiles) to be able to screw the locking handle in place. U.S. Pat. No. 9,777,509 shows also a screw installation from behind, but with an added retainer. The retainer is specific to the depth of the profile but allows to have a single cut.

Casement locking handles are usually protruding by approximately 8-25 mm depending on the design. U.S. Pat. No. 5,087,087 shows a mechanism that is concealed in the profile, but the tip of lever is protruding in locked and unlocked position, because it doesn't rotate a full 180°. U.S. Pat. No. 5,813,710 shows a low-profile design, both in locked and unlocked positions, but with a few key disadvantages. Mainly, it requires a higher force to operate, because the lever handle is shorter, and it also requires a separate mechanism to block the handle from pivoting. U.S. Pat. No. 5,829,802 shows a locking handle with most of the mechanism protruding from the window frame. The handle rotates a full 180° but is always outside of the profile. U.S. Pat. No. 9,725,934 shows a low-profile locking handle protruding by about 12 mm in the locked position. The lever tip is protruding further in unlocked position because it cannot reach a whole 180°. The linkage member of the mechanism is also visible in the unlocked position, which is not aesthetic. U.S. Pat. No. 9,777,509 shows also a low-profile locking handle with a similar mechanism principle as the previous patent. A lifter track is added to the mechanism, which allows it to be protruding by about 8-10 mm in the locked position. It has the same disadvantages as the previous one: lever tip protruding and visible linkage member in unlocked position. An additional disadvantage of this design is that a hole with the exterior is created when in the unlocked position. Its retainer acts as a mosquito screen, but it only partially covers the hole and does not seem a durable solution.

Accordingly, there is a need for a locking handle mechanism that is simple to install, that may substantially not be protruding from the casement when in locked or unlocked position, that may be installed on either side of a window frame and that may further be detachably secured to various profiles of window frames.

### SUMMARY OF THE INVENTION

The aforesaid and other objectives of the present invention are realized by generally providing a locking handle mechanism comprising: a main body; a slider slideable in the main body; and a handle having a pivot point within the main body and being pivotable between a first position and a second position, wherein the handle slides the slider when pivoted between the first position and the second position, and wherein the handle is substantially housed within the main body in the first position and in the second position.

In another aspect of the invention, the handle has a sliding part extending from the pivot point, the sliding part sliding the slider in the main body when the handle is pivoted between the first position and the second position. The sliding part may be guided by a slot in the slider. The slot may extend downwardly. The slot may have a soft lock mechanism at a first extremity for soft locking the sliding part when the handle is in the first position and in the second position, the main body may comprise elastically deformable tabs for soft locking the locking handle mechanism when the handle is pivoted in the first position or in the second position, the slider abutting against one of the tabs when the handle is in the first position and in the second position. The locking handle mechanism may be usable in a right side or a left side configuration of a vertical casement. The slider may comprise a side slit on each of two sides of the slot, the side slits extending downwardly and having an open end downward of the slider, the side slits configured to receive a locking mechanism of the vertical casement from the open end.

In another aspect of the invention the locking handle mechanism may comprise a cover detachably secured to the main body, the cover being entirely housed within the main body and having a notch for receiving the pivot point of the handle.

In yet another embodiment of the invention, the locking handle mechanism may comprise at least one snap fit on the main body, the at least one snap fit being configured to be secured to a frame, the at least one snap fit comprising a hook for securing to an interior side of the frame having a first thickness. The at least one snap fit may further comprise a second hook for securing to the interior side of the frame having a second thickness. The at least one snap fit may be configured to be unsecured from the frame by pressure on an extremity of the at least one snap fit.

In another aspect of the invention, the handle may be fully housed within the main body in the first position and in the second position. The handle may be pivotable 173 degrees around the pivot point.

In another aspect of the invention, the locking handle mechanism may be usable in a casement of a window or a door. The casement may comprise a frame, the main body having a top surface being substantially leveled with an exterior side of the frame.

In an aspect of the invention, a method of installing a locking handle mechanism to a window casement is provided, the method comprising the steps of: inserting the locking handle mechanism in a hole in the window casement having complementary dimensions to the locking handle mechanism; aligning a slit of a slideable slider of the locking handle mechanism with a locking mechanism of the window casement; and securing the locking handle mechanism to the window casement with snap fit members. The method may further comprise: measuring exterior dimensions of the locking handle mechanism; and creating a hole in a fixed portion of the window casement corresponding to the exterior dimensions of the locking handle mechanism. The method may further comprise: abutting a first section of the locking handle mechanism to a first side of the hole; and abutting a second section of the locking handle mechanism opposite to the first section to a second side of the hole opposite to the first side.

In yet another aspect of the invention, a locking handle mechanism is provided, comprising: a main body; a handle configured to lock and unlock the mechanism; and at least one snap fit secured to the main body, wherein the at least one snap fit is configured to be secured to a frame, the at least one snap fit comprising a hook for securing to an interior side of the frame having a first thickness. The at least one snap fit may further comprise a second hook for securing to the interior side of the frame having a second thickness. The at least one snap fit may be configured to be unsecured from the frame by pressure on an extremity of the at least one snap fit. The main body may comprise a top surface configured to be substantially leveled with an exterior side of the frame.

The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of a locking handle mechanism in accordance with the principles of the present invention.

FIG. 2 is an exploded view of the locking handle mechanism of FIG. 1 in accordance with the principles of the present invention.

FIG. 3 is a side view of a fork of a locking handle mechanism in accordance with the principles of the present invention.

FIG. 4 is a side view of a locking handle mechanism in a casement window in accordance with the principles of the present invention.

FIG. 5 is a top sectional view of a locking handle mechanism installed in a casement window frame in accordance with the principles of the present invention.

FIG. 6 is a perspective view of a locking handle mechanism installed in a casement window frame in accordance with the principles of the present invention.

FIG. 7 is a perspective view of a locking handle mechanism in a casement window frame in an unlocked configuration in accordance with the principles of the present invention.

FIG. 8 is a perspective view of a locking handle mechanism in a casement window frame in a locked configuration in accordance with the principles of the present invention.

FIG. 9 illustrates a method of installing a locking handle mechanism to a frame in accordance with the principles of the present invention.

FIG. 10 illustrates a method of uninstalling a locking handle mechanism to a frame in accordance with the principles of the present invention.

FIG. 11 illustrates a method of manipulating a locking handle mechanism in accordance with the principles of the present invention.

### DETAILED DESCRIPTION OF THE PREFERRED EMBODIMENT

A novel locking handle mechanism will be described hereinafter. Although the invention is described in terms of specific illustrative embodiment(s), it is to be understood that the embodiment(s) described herein are by way of example only and that the scope of the invention is not intended to be limited thereby.

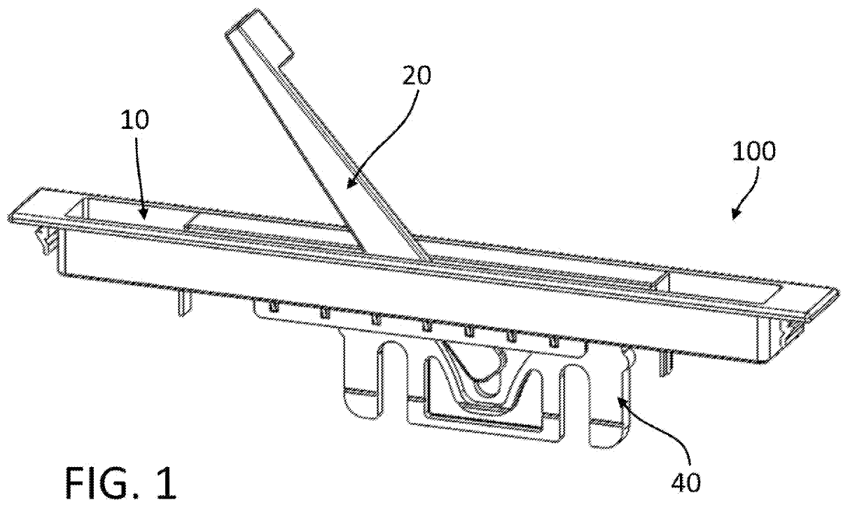

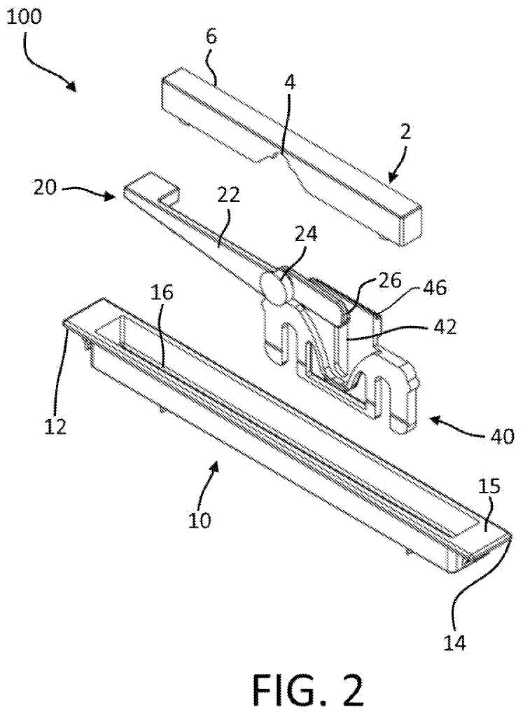

Referring to FIG. 1, a locking handle mechanism 100, or locking handle, is shown. The locking handle mechanism 100 comprising a main body 10, a handle 20 and a fork 40 is configured to be installed in a casement comprising a fixed frame and a moving sash, wherein the sash may be locked and unlocked from the frame. The described embodiment below generally describes a casement window. While the preferred window embodiment is a casement window, it may be understood that any other type of window may be used with the invention, such as an awning window. It may further be noted that the locking handle mechanism 100 is not only limited to windows and, for example may also be used with doors. The main body 10 of the mechanism is configured to house and support other components of the locking handle mechanism 100. The handle 20 is configured to be manipulated by a user and moved from a first position to a second position. The first position is generally at an end 12 of the main body 10 and the second position is generally at the other end 14 of the main body 10 as seen in FIG. 2. Understandably, the longitudinal axis of the handle 20 may be substantially parallel to the length of the main body 10 when in the first and second positions. The fork 40 is configured to be displaced following the manipulation of the handle 20 in order to lock or unlock a locking system of the casement window.

Referring now to FIG. 2, the locking handle mechanism 100 may further comprise a cover 2. The cover 2 is configured to be installed over the handle 20 to prevent external unwanted particles from entering inside the locking handle mechanism 100. It may further be used as a visual aesthetic cover so that users may not see inside the locking handle mechanism 100. In a first embodiment, the cover 2 is fixedly installed to the main body 10 of the locking handle mechanism 100 and the movement of the handle 20 that is moving between a first position and a second position is pivoting in a notch 4 of said cover 2. The notch 4 may have a plurality of shapes, though the preferred embodiment is a circle. The notch 4 may be the pivot point of the handle 20. In a second embodiment, the cover 2 is detachably installed to the handle 20 and is displaced when said handle 20 is displaced by a user between the first position and the second position. In the second embodiment, the notch 4 is snap fitted to part of the handle 20 and may be slid inside and possibly outside the main body 10 of the locking handle mechanism 100. Further comprised in the cover 2 may be a sliding support 6, not shown, configured to slide the fork 40. The sliding support 6 is usually embodied as a rail and is located opposite to the main body 10 in view of the fork 40.

The embodied handle 20 of FIG. 2 is configured to be manipulated by a user between a first position and a second position. The first position may generally be configured to lock the casement and the second position may generally be configured to unlock the casement. In either of the two positions, the handle 20 is substantially or entirely housed within the main body 10 of the mechanism 100 and an elongated part 22 may be at one of the two opposite ends (12, 14) of the main body 10. It may be appreciated that the handle 20 may thus only protrude from the main body 10 of the mechanism 100 when rotated in-between the first and the second positions since it may rotate around the pivot point that is at the notch 4 of the cover 2. In a specific embodiment, the handle 20 may rotate about 173 degrees from the first to the second position. The first and second positions may be angled from one another for any other angles, for example 90 degrees, 180 degrees, etc. The handle 20 may be detachably fixed to the cover 2 presented above and is adapted to be in working configuration with the fork 40 of the locking handle mechanism 100. The handle 20 comprises a manipulable section 22, usually the elongated part adapted to be held by a user, a pivoting part 24, embodied as a round part, and a sliding part 26, not shown. The sliding part 26 may generally be shaped as a button extruded from the handle 20, however it may have any other shape known in the art. The sliding part 26 is configured to slide in a slot 42, also referred to as central slot or central slit, of the fork 40 when the handle 20 is displaced and may further be configured to be snap fitted to the fork 40 when said handle 20 is in the first or second position. The sliding part 26 is configured to offer resistance when the handle 20 is leaving or entering the first or second position so that a user may know when said positions, generally associated with locking or unlocking the casement, are reached or left. The resistance to leave or enter the first position and the second position may further help immobilize the handle 20 when not manipulated by a user and/or it may prevent a child or animal lacking the required strength to change the state of the locking handle mechanism 100. The combination of the handle 20 being at a full or almost full vertical position relative to the frame in the first and second positions and the fact that the sliding part 26 is generally closer to the pivoting part 24 than the end of the elongated part of the handle 22, thus requiring a much higher force to rotate said handle 20 due to the shortened distance, may make the locking and most importantly the unlocking of the window hard if not impossible for a user from the exterior of a building to which the locking handle mechanism 100 is installed to. The current mechanism 100 is thus configured to be safe against back driving of the fork 40 of the locking handle mechanism 100. The pivoting part 24 and the sliding part 26 are located at a certain distance from each other's to further allow the cover 2 to be in contact with the pivoting part 24 when the sliding part 26 is displaced downwards in the slot 42 of the fork 40. Understandably, the dimensions and shape of the parts comprised in the handle 20 may vary and are not limited to the above recited embodiments.

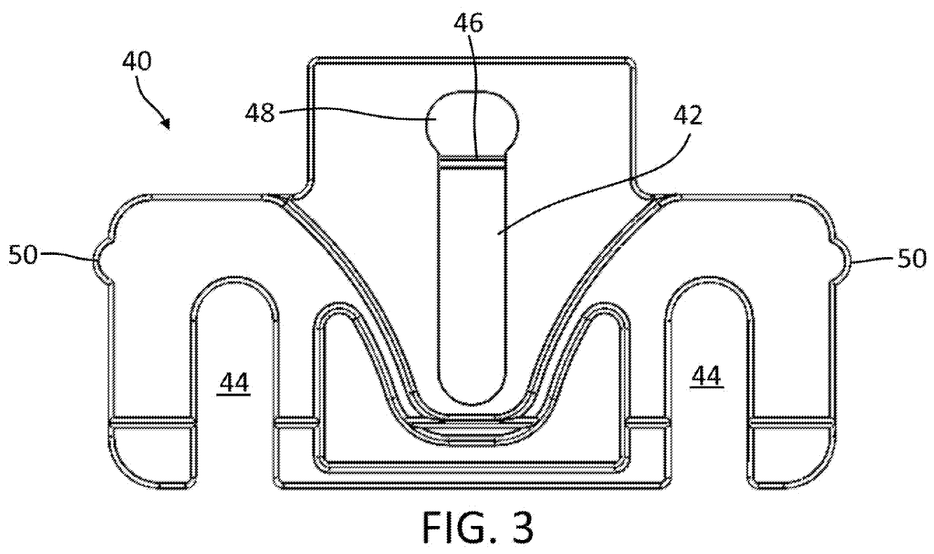

Referring now to FIG. 3, an embodiment of a fork 40, also referred to as a slider, of the locking handle mechanism 100 is shown. The fork 40 comprises a slot 42 generally located in the middle section of the fork 40. The central slot 42 is configured to receive the sliding part 26 of the handle 20 which may be slid along the shape of said slot 42. Accordingly, the slot 42 will control the possible displacement of the sliding part 26 of the handle 20. The fork 40 may further comprise two side slits 44 configured to receive attachment means from an external locking mechanism. In a preferred embodiment, the fork 40 comprises two side slits 44, but it may be understood that more or less side slits 44 may be comprised. For example, having more side slits 44 may allow more possibilities to fit the fork 40 with attachment means from external locking mechanisms. The side slits 44, being located on the sides of the central slot 42 rather than directly below said slot 42 may allow for a more compact depth of the fork 40 and coincidentally of the locking handle mechanism 100 which may then allow the installation of the locking handle mechanism 100 in thin window frames. The shape and size of each of the above mentioned slits and slot (42, 44) may vary and are not limited to the embodiments shown. For example, the side slits 44 may be holes allowing the insertion of tabs of an external locking mechanism. In order for the fork 40 to slide between the cover 2 and the main body 10, a rail 46 is comprised. The rail 46 allows the fork 40 to be displaced in the main body 10. Understandably, any mechanism known in the art for sliding an object in another object may be used, such as wheels, balls, etc.

Further comprised in the fork 40 may be a soft lock mechanism 48 adapted to receive the sliding part 26 of the handle 20 when said handle 20 is in the first or second position. The embodied soft lock mechanism 48 is a round point, but it may have any other shape with the same function in other embodiments, and is configured to open up in the central slot 42 so that the sliding part 26 of the handle 20 may enter or leave the central slot 42 from said soft lock mechanism 48. The soft lock mechanism 48 is configured to provide resistance against the displacement of the sliding part 26 of the handle 20 when said handle 20 is manipulated to enter or leave the first and the second positions.

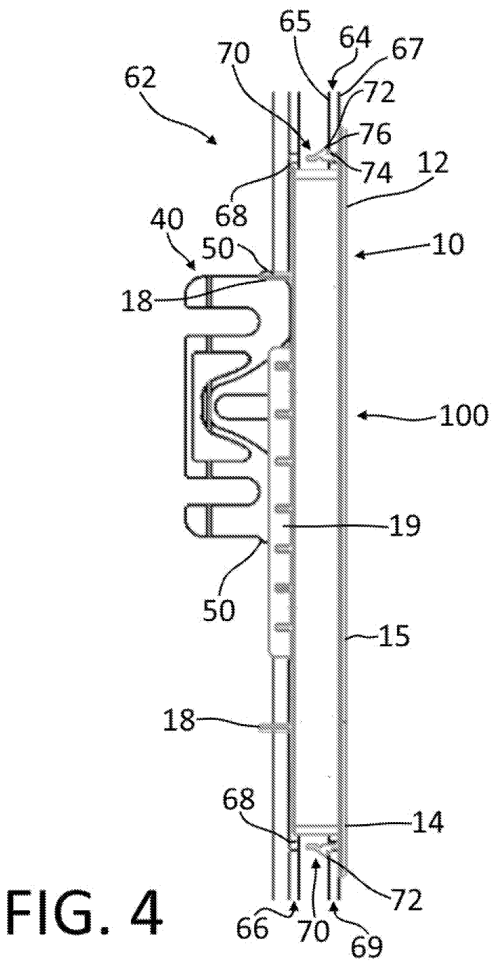

Now referring to FIG. 4, an embodiment of a locking handle mechanism 100 is installed in a first section 62 of a casement window 60. The main body 10 of the locking handle mechanism 100 is configured to fit in the depth of the first section of the casement 62 and the fork 40 is protruding at the back of said first section 62. It may be appreciated that the handle 20 and cover 2 are housed within the depth of the main body 10 and thus do not protrude in the front of said main body 10. The main body 10 may partly house the fork 40; the fork 40 being supported by a protuberance 16, shown in FIG. 2, of the main body 10 in working configuration with the rail 46 of the fork 40 and the sliding support 6 of the cover 2. The fork 40 may be located between two tabs 18. The tabs 18 are configured to soft lock the fork 40 when the handle 20 is at the first or second position. To do so, bumps 50 on the body of the fork 40 may enter in contact with the tabs 18 which may then push against the displacement of the fork 40. The tabs 18 may be made of any material allowing slight deformation to provide force feedback to a user manipulating the locking handle mechanism 100. A user may thus feel satisfactory feedback from the tabs 18 confirming when the locking handle mechanism 100 arrives at the first or second position. Further comprised in the locking handle mechanism 100 may be a guiding edge 19. There may only be one guiding edge 19 on a side of the fork 40 or there may be at least two guiding edges 19, one at each side of the fork 40. The guiding edge 19 is configured to stabilize the fork 40 and prevent unwanted rotary movements of the fork 40 on the sides while still allowing up and down translation.

Still referring to FIG. 4, the main body 10 may further comprise snap fits 70, such as the embodied but not limited to cantilever snap fits, configured to secure the locking handle mechanism 100 to a casement window's frame 62. The casement window's frame 62 to be secured to is generally the frame portion of a window that is fixed, but it may vary depending on the types of windows used with the locking handle mechanism 100. In one embodiment of the invention, there may be two snap fits 70 to secure the locking handle mechanism 100, one at the upper and one at the lower extremities (12, 14). In another embodiment of the invention, there may only be one snap fit 70 located at one extremity, either the topmost or the lowermost, of the locking handle mechanism 100. In this embodiment, the extremity of the locking handle 100 not comprising the snap fit 70 may be abutted to the frame 62 of the window 60. In yet other embodiments, there may be more than two snap fits 70 to secure the locking handle mechanism 100, said snap fits 70 possibly located on the top, bottom or sides of the main body 10. It will be understood that comprising snap fits 70 on the main body 10 may allow the locking handle mechanism 100 to be installed in a window's casement 60 without the need to use fasteners such as screws.

The snap fits 70 may be located at the edges of the main body 10 so that a hook 72 may be secured to the interior side 65 of the casement's outer surface 64. There may be one or a plurality of hooks 72 for allowing varying thicknesses of casement's outer surfaces 64, the thickness 69 being from the interior side 65 to the exterior side 67 of the outer surface 64. The embodiment shown comprises two hooks (74, 76) and may thus be secured to two approximate thicknesses 69 of outer surfaces 64. For example, the smaller hook 74 may be used for thicknesses 69 of approximately 1.7 mm wherein the larger hook 76 may be used for thicknesses 69 of approximately 3 mm. Understandably, other embodiments may comprise three or more hooks. In some embodiments, the snap fits 70 may comprise modular hooks 72 which may be added or removed based on the thickness 69 required to secure.

In one embodiment of the invention, the snap fits 70 may be manufactured unitarily with the main body 10 of the locking handle mechanism 100. In another embodiment, the snap fits 70 may be manufactured separately from the main body 10 and may be required to be secured to the main body 10 either before or during installation of the locking handle mechanism 100 to the frame of a window 60. If the snap fits 70 are manufactured separately from the main body 10, they may be secured to said main body 10 by any fastening means known in the art, such as glue, screws or a snap fit mechanism for example.

The inner surface 66 of the window casement 62 may comprise entry points 68 to permit the use of tools to disengage the hooks 72 of the snap fits 70 to the casement's exterior surface 64. The entry points 68 may be holes in the frame 62 in line with the snap fits 70 or they may be included in a pre-cut area for the insertion of the locking handle mechanism 100 in the frame 62. The snap fits 70 may thus be configured to be unhooked when the topmost point is pressed. For example, a user may enter a toothpick or the end of a screwdriver through a hole located in the inner surface 66 of the casement 62 to push against a snap fit 70 of the locking handle mechanism 100, thus disengaging a hook 72 of the snap fit 70 from the outer surface 64 of the casement 62. Understandably, the locking handle mechanism 100 may be removed of a window frame 60 with limited risks of breaking or damaging the locking handle mechanism 100 or the window frame 60.

It may be appreciated that the main body 10 may comprise a top surface 15 that is leveled with the exterior side 67 of the outer surface 64. In some embodiment, the top surface 15 of the main body 10 may be entirely leveled with the exterior side 67 of the outer surface 54 wherein other embodiments, it may be substantially leveled. Thus, with the main body's top surface 15 at least substantially leveled with the exterior side 67 of the frame 62, it may be appreciated that the mechanism 100 substantially does not protrude out from the exterior side 67 when the handle 20 is in the first or second positions.

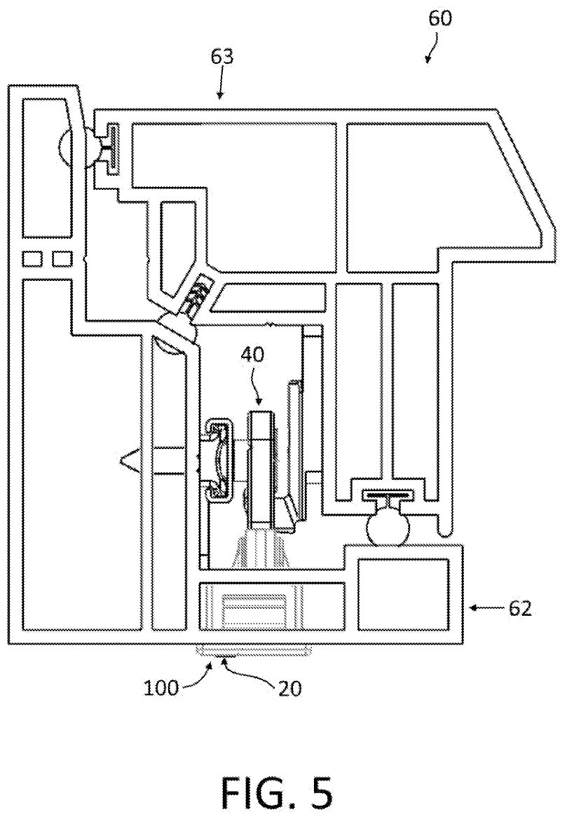

Now referring to FIG. 5, a locking handle mechanism 100 is installed in a first section 62 of a casement window 60 and is connected to a locking mechanism 100 of the window 60. The first section 62 being a frame and comprising the locking handle mechanism 100 is fixed wherein the second section 63 being a sash is movable when the locking mechanism 100 is unlocked. It may be appreciated that given the compactness of the locking handle mechanism 100 due to the configuration of the fork 40 with the handle 20, the locking handle mechanism's 100 dimensions may be more compact than other locking handle mechanisms 100 usually found in the prior art. For example, the width of the locking handle mechanism 100 may be of approximately 17 mm, the depth of the main body 10 may be of approximately 12.5 mm and the depth from the outer surface of the main body 10 to the middle of the fork 40 may be of approximately 21.5 mm.

Understandably, the dimensions of the locking handle mechanism 100, and specifically of the main body 10, may be manufactured to be leveled, also referred to as flush fitted, to various depths of fixed portions of casement windows 60. To install the locking handle mechanism 100, it is thus required to measure the dimensions of the main body 10 of the locking handle mechanism 100 and to pierce a hole in the first section 62 of the casement window 60 in accordance with said dimensions. Given the simplicity of use of the snap fits 70 to secure the main body 10 of the locking handle mechanism 100, no significant use of tooling should be required for the installation of the locking handle mechanism 100 once the pierced hole has been created in accordance with the dimensions of the main body.

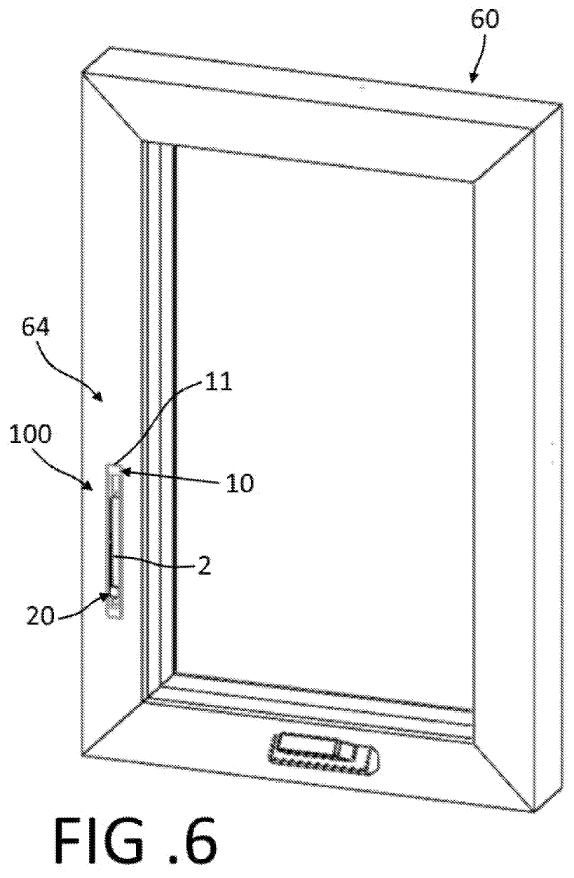

Now looking at FIG. 6, a perspective view of the locking handle mechanism 100 installed in a casement window 60 is shown for the point of view of a user in a building. It may be appreciated that the locking handle mechanism 100, more precisely the cover 2, the handle 20 and the main body 10, is installed in a leveled configuration with the casement window's surface 64 facing the interior of the building wherein a user would manipulate said locking handle mechanism 100. Only a slight protrusion 11 from the top surface 15 of the main body 10, measuring only a few millimetres or less, may be required to fix the main body 10 to the casement window 60. To be precise, when the locking handle mechanism 100 is in the first or second position, there are no parts protruding away from the exterior surface 64 of the casement 60. This feature may be functionally efficient as it may save space around the casement window 60, avoid interference with blinds or shades, and it may prevent people to hurt themselves against protruding parts from the casement window 60. It may also be aesthetically pleasing for users to look at. The locking handle mechanism 100 could be installed in either side of the casement window 60 and on the top or bottom sections if an awning window is selected.

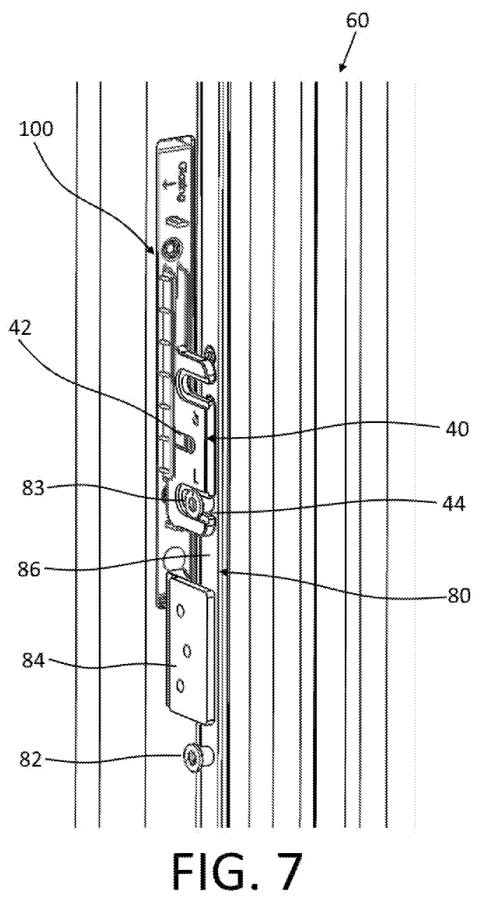

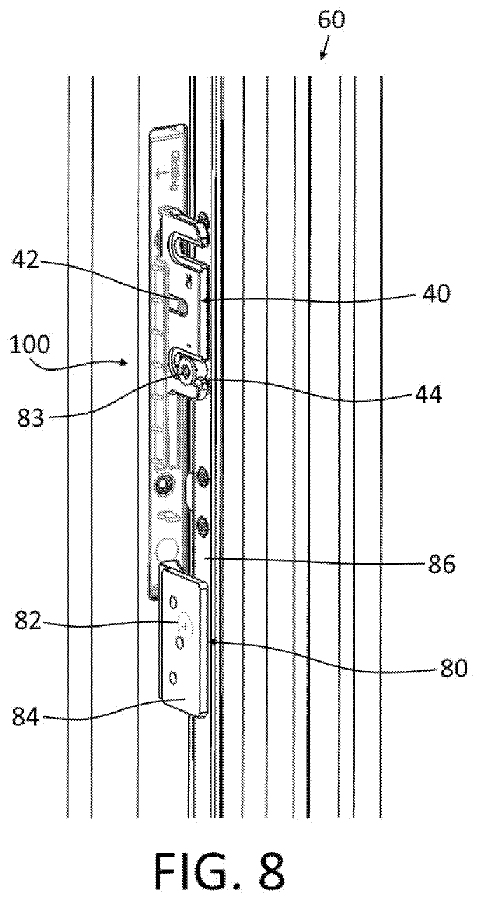

Referring now to FIGS. 7 and 8, a locking handle mechanism 100 in a working configuration with a locking mechanism 80 of a casement window 60, wherein the casement window 60 is in unlocked and locked positions respectively. The locking mechanism 80 of the casement window 60 shown is a system comprising sliding studs 82, also referred to as cams, and one or multiple blocking plates 84, also referred to as keepers. The blocking plate 84, secured to the moveable section 63 of the casement window 60, is configured to be blocked by a sliding stud 82 and may be unblocked by sliding the stud 82 away. A stud 83 of the locking mechanism 80, or any other extruding part of the same, is configured to be housed within a side slit 44 of the fork 40 of the locking handle mechanism 100. It may be appreciated that in the embodiments comprising two side slits 44, with one 44 at least on each side of the central slot 42, the locking handle mechanism 100 is adapted to be installable on the left or right side of a casement window 60 by flipping the locking handle mechanism 100 upside down to mirror the position of the cams 82 and blocking plate(s) 84. When the fork 40 is displaced upwards or downwards, the corresponding stud 83 will be displaced accordingly, thus activating a moveable part 86 of the locking mechanism 80, such as a displaceable bar, which will then displace a second stud 82 that may block or unblock the blocking plate 84. It may be understood that any other locking mechanism 100 which may be activated by the displacement of the fork 40 of the locking handle mechanism 100 may be used.

Referring back to FIGS. 1 and 2, in an embodiment of the invention, the locking handle mechanism 100 is activated by a user manipulating the elongated part 22 of the handle 20. The handle 20, starting for example in the first position with the manipulable extremity 22 at an end (12 or 14) of the main body 10, may be rotated towards the other end (12 or 14) of the main body 10 that is the second position. The handle's 20 center of rotation is the pivoting part 24 which stays fixed in relation to the casement window 60. By rotating the handle 20 around the pivoting part 24, the sliding part 26 that is located opposite to the elongated part 22 of the handle 20 relative to pivoting part 24 is likewise rotated. When starting the rotational movement of the handle 20, the sliding part 26 of the handle 20 is housed within the soft lock mechanism 48 of the fork 40 and may thus leave said soft lock mechanism 48 with resistance before entering the central slot 42 of the fork 40. By rotating the sliding part 26 of the handle 20 with the handle 20 moving from the first position to the second position, the fork 40 will be displaced accordingly by being dragged by the slot 42 with the sliding part 26 of the handle 20. Understandably, the length of the slot 42 is adapted to house the sliding part 26 of the handle 20 even when the handle 20 is at the middlemost position of the rotation. Furthermore, the distance between the sliding part 26 of the handle 20 and the pivoting part 24 of the handle 20 is configured to allow the locking mechanism 100 to be sufficiently displaced for blocking and/or unblocking the casement window 60. When arriving at the second position, the sliding part 26 of the handle 20 may enter the soft lock mechanism 48 with some resistance.

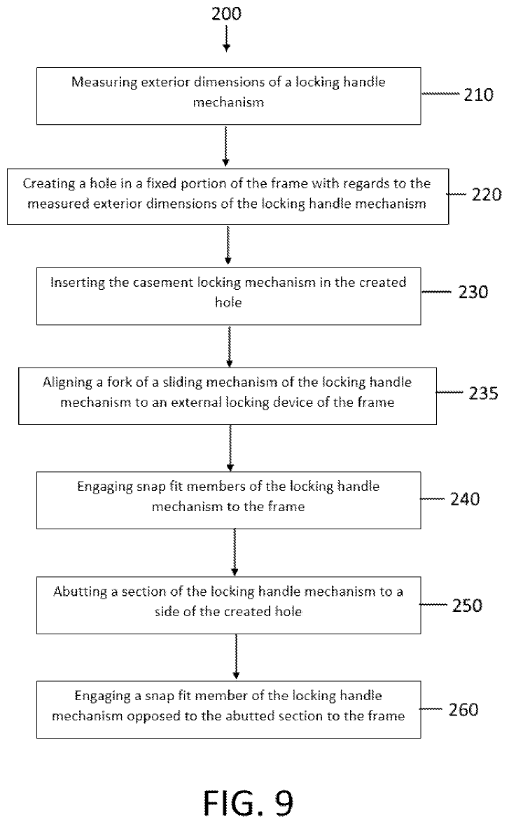

Now referring to FIG. 9, a method of installing a locking handle mechanism to a frame 200 is provided. The method 200 may comprise the steps of: measuring exterior dimensions of a locking handle mechanism 210, creating a hole in a fixed portion of the frame with regards to the measured exterior dimensions of the locking handle mechanism 220, inserting the casement locking mechanism in the created hole 230 and engaging snap fit members of the locking handle mechanism to the frame 240. The step of engaging snap fit members of the locking handle mechanism to the frame 240 may be replaced by the step of abutting a section of the locking handle mechanism to a side of the created hole 250 and engaging a snap fit member of the locking handle mechanism opposed to the abutted section to the frame 260. The method may further comprise the step of aligning a fork of a sliding mechanism of the locking handle mechanism to an external locking device of the frame 235.

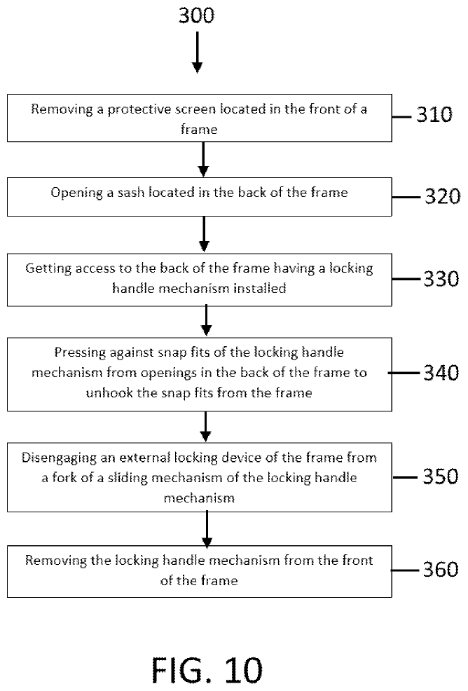

In another embodiment shown on FIG. 10, a method of uninstalling a locking handle mechanism to a frame having a front and a back 300 is provided. The method 300 may comprise the steps of: removing a protective screen located in the front of a frame 310, opening a sash located in the back of the frame 320, getting access to the back of the frame having a locking handle mechanism installed 330, pressing against snap fits of the locking handle mechanism from openings in the back of the frame to unhook the snap fits from the frame 340, disengaging an external locking device of the frame from a fork of a sliding mechanism of the locking handle mechanism 350 and removing the locking handle mechanism from the front of the frame 360. The method may comprise the use of any tools known in the art to press against the snap fits 70 of the handle mechanism 100, such as a screwdriver.

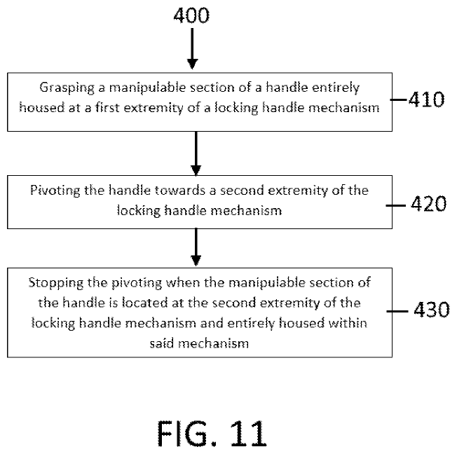

In yet another embodiment shown on FIG. 11, a method of locking or unlocking a frame 400 is provided, the method 400 comprising using a locking handle mechanism 100 in accordance with the embodiments described above and comprising the steps of: grasping a manipulable section of a handle entirely housed at a first extremity of the locking handle mechanism 410, pivoting the handle towards a second extremity of the locking handle mechanism 420, stopping the pivoting when the manipulable section of the handle is located at the second extremity of the locking handle mechanism and entirely housed within said mechanism 430. Understandably, any of the above recited methods may further be applied to, but not limited to, frames of windows, such as casement of awning windows, or of doors.

While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1) A locking handle mechanism, comprising:
a main body;
a slider slideable in the main body; and
a handle having a pivot point within the main body and being pivotable between a first position and a second position,
wherein the handle slides the slider when pivoted between the first position and the second position, and wherein the handle is substantially housed within the main body in the first position and in the second position.

2) The locking handle mechanism of claim 1, the handle having a sliding part extending from the pivot point, the sliding part sliding the slider in the main body when the handle is pivoted between the first position and the second position.

3) The locking handle mechanism of claim 2, the sliding part being guided by a slot in the slider.

4) The locking handle mechanism of claim 3, the slot extending downwardly.

5) The locking handle mechanism of claim 4, the slot having a soft lock mechanism at a first extremity for soft locking the sliding part when the handle is in the first position and in the second position, the main body comprising elastically deformable tabs for soft locking the locking handle mechanism when the handle is pivoted in the first position or in the second position, the slider abutting against one of the tabs when the handle is in the first position and in the second position.

6) The locking handle mechanism of claim 3, being usable in a right side or a left side configuration of a vertical casement.

7) The locking handle mechanism of claim 6, the slider comprising a side slit on each of two sides of the slot, the side slits extending downwardly and having an open end downward of the slider, the side slits configured to receive a locking mechanism of the vertical casement from the open end.

8) The locking handle mechanism of claim 1, comprising a cover detachably secured to the main body, the cover being entirely housed within the main body and having a notch for receiving the pivot point of the handle.

9) The locking handle mechanism of claim 1, comprising at least one snap fit on the main body, the at least one snap fit being configured to be secured to a frame, the at least one snap fit comprising a hook for securing to an interior side of the frame having a first thickness.

10) The locking handle mechanism of claim 9, the at least one snap fit further comprising a second hook for securing to the interior side of the frame having a second thickness.

11) The locking handle mechanism of claim 9, the at least one snap fit configured to be unsecured from the frame by pressure on an extremity of the at least one snap fit.

12) The locking handle mechanism of claim 1, the handle being fully housed within the main body in the first position and in the second position.

13) The locking handle mechanism of claim 1, the handle being pivotable 173 degrees around the pivot point.

14) The locking handle mechanism of claim 1, being usable in a casement of a window or a door.

15) The locking handle mechanism of claim 14, the casement comprising a frame, the main body having a top surface being substantially leveled with an exterior side of the frame.

16) A method of installing a locking handle mechanism to a window casement, the method comprising the steps of:
inserting the locking handle mechanism in a hole in the window casement having complementary dimensions to the locking handle mechanism;
aligning a slit of a slideable slider of the locking handle mechanism with a locking mechanism of the window casement;
securing the locking handle mechanism to the window casement with snap fit members.

17) The method of claim 16, the method further comprising:
measuring exterior dimensions of the locking handle mechanism;
creating a hole in a fixed portion of the window casement corresponding to the exterior dimensions of the locking handle mechanism.

18) The method of claim 16, the method further comprising:
abutting a first section of the locking handle mechanism to a first side of the hole;
abutting a second section of the locking handle mechanism opposite to the first section to a second side of the hole opposite to the first side.

19) A locking handle mechanism, comprising:
a main body;
a handle configured to lock and unlock the mechanism; and
at least one snap fit secured to the main body,
wherein the at least one snap fit is configured to be secured to a frame, the at least one snap fit comprising a hook for securing to an interior side of the frame having a first thickness.

20) The locking handle mechanism of claim 19, the at least one snap fit further comprising a second hook for securing to the interior side of the frame having a second thickness.

21) The locking handle mechanism of claim 19, the at least one snap fit configured to be unsecured from the frame by pressure on an extremity of the at least one snap fit.

22) The locking handle mechanism of claim 19, the main body comprising a top surface configured to be substantially leveled with an exterior side of the frame.
